(19) United States
(12) Patent Application Publication
(10) Pub. No.: US 2026/0349799 A1
(43) Pub. Date: Nov. 5, 2026

(54) CACHE MANAGEMENT FOR MULTIPLE APPLICATIONS

(71) Applicant: Hewlett Packard Enterprise Development LP, Spring, TX (US)

(72) Inventors: Sekwon Lee, Austin, TX (US); Sharad Singhal, Belmont, CA (US); Harumi Kuno, Cupertino, CA (US); Clarete Riana Crasta, Bangalore (IN); John L. Byrne, Pasadena, CA (US); Abhishek Dwaraki, Pearland, TX (US)

(21) Appl. No.: 19/195,284

(22) Filed: Apr. 30, 2025

(51) Int. Cl. G06F 9/50

(52) U.S. Cl. CPC G06F 9/5016; G06F 9/5038; G06F 9/5044

(57) ABSTRACT

A system determines, by a network device, a total capacity of a cache to be used by multiple applications, the cache comprising memory distributed across a plurality of compute nodes. The system allocates, of the total capacity, a cache partition for a respective application, by: determining a desired cache capacity over a current first time interval; determining an updated target hit rate based on at least a measured quality-of-service (QoS) value over a prior second time interval; and adjusting the desired cache capacity over the current first time interval based on the updated target hit rate.

### BACKGROUND

Managing performance across multiple applications sharing limited resources, such as a distributed global cache, presents significant challenges. Two key considerations are: (1) determining optimal cache capacity per application, and (2) balancing cache allocation among applications. While traditional caching algorithms like Least Recently Used (LRU) and Least Frequently Used (LFU) are commonly employed for data eviction when the cache reaches capacity, they fail to provide adequate performance isolation between applications and may inadvertently favor one workload at the expense of another.

### BRIEF DESCRIPTION OF THE FIGURES

FIG. 1A illustrates an environment which facilitates cache management for multiple applications, including multiple local capacity controllers and a global arbiter controller, in accordance with an aspect of the present application.

FIG. 1B illustrates a diagram of a global cache space with allocated cache partitions based on the environment of FIG. 1A, in accordance with an aspect of the present application.

FIG. 2A depicts an adaptive cache capacity controller, in accordance with an aspect of the present application.

FIG. 2B depicts an adaptive cache capacity controller, including a global arbiter controller, in accordance with an aspect of the present application.

FIG. 3 presents a flowchart illustrating a method which facilitates cache management for multiple applications, in accordance with an aspect of the present application.

FIG. 4A presents a flowchart illustrating a method which facilitates cache management for multiple applications, in accordance with an aspect of the present application.

FIG. 4B presents a flowchart illustrating a method which facilitates cache management for multiple applications, in accordance with an aspect of the present application.

FIG. 5 illustrates a computer system which facilitates cache management for multiple applications, in accordance with an aspect of the present application.

FIG. 6 illustrates a computer-readable medium which facilitates cache management for multiple applications, in accordance with an aspect of the present application.

In the figures, like reference numerals refer to the same figure elements.

### DETAILED DESCRIPTION

Aspects of the present application provide a system which facilitates cache management for multiple applications by providing an adaptive cache capacity controller.

Managing performance across multiple applications sharing limited resources, such as a distributed global cache, presents significant challenges. Two key considerations are: (1) determining optimal cache capacity per application, and (2) balancing cache allocation among applications. While traditional caching algorithms like Least Recently Used (LRU) and Least Frequently Used (LFU) are commonly employed for data eviction when the cache reaches capacity, they fail to provide adequate performance isolation between applications and may inadvertently favor one workload at the expense of another.

The described aspects provide a system which facilitates cache management for multiple applications by partitioning the global cache and allocating a fraction of the total cache capacity to individual applications based on several factors, including, e.g., a target Quality of Service (QoS) value, a measured QoS value, a target hit rate, and a measured hit rate of an application over a certain time interval. The described system can provide an adaptive cache capacity controller which includes two types of controllers: a local capacity controller; and a global arbiter controller.

The local capacity controller (LCC) for each application can concurrently perform two functions. First, the LCC for a respective application can adjust the requested cache capacity for that respective application based on the previously assigned capacity and the difference between target and measured hit rates. Second, the LCC can modify the target hit rate based on its previous value and the discrepancy between target and measured QoS values. This adjusted target hit rate can be used to compute further cache capacity requests. The LCC may perform these two functions in a nested loop, where the first function may be performed over a first time interval and the second function may be performed over a second time interval which is greater than the first time interval.

The global arbiter controller (GAC) can allocate a fraction of the total cache capacity (or a “cache partition”) to multiple LCCs for their respective applications by evaluating each application's requested capacity against its minimum acceptable capacity, relative priority, and a weight factor for allocating any surplus capacity. In this disclosure, the terms “global arbiter controller” and “global cache controller” may be interchangeably used.

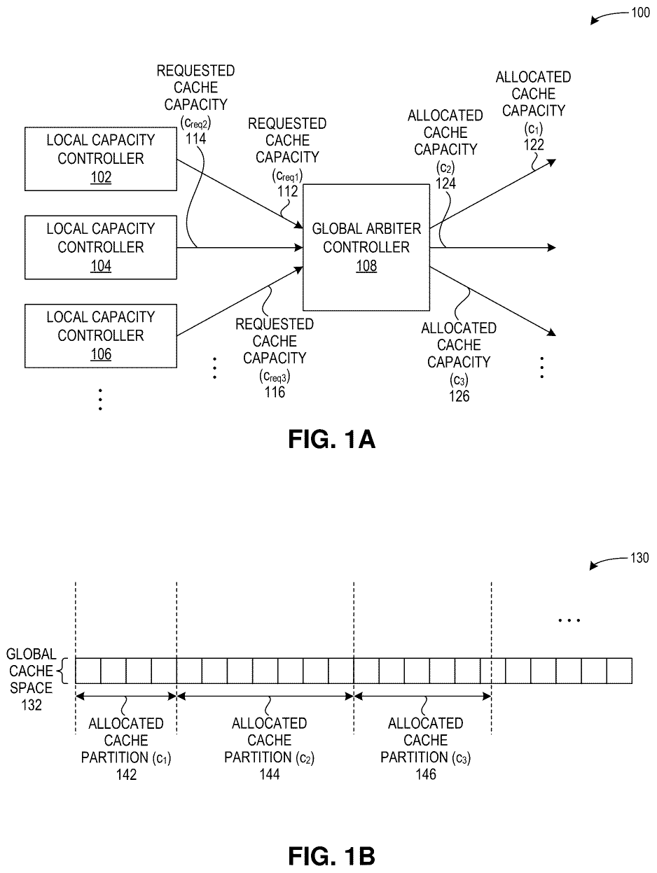

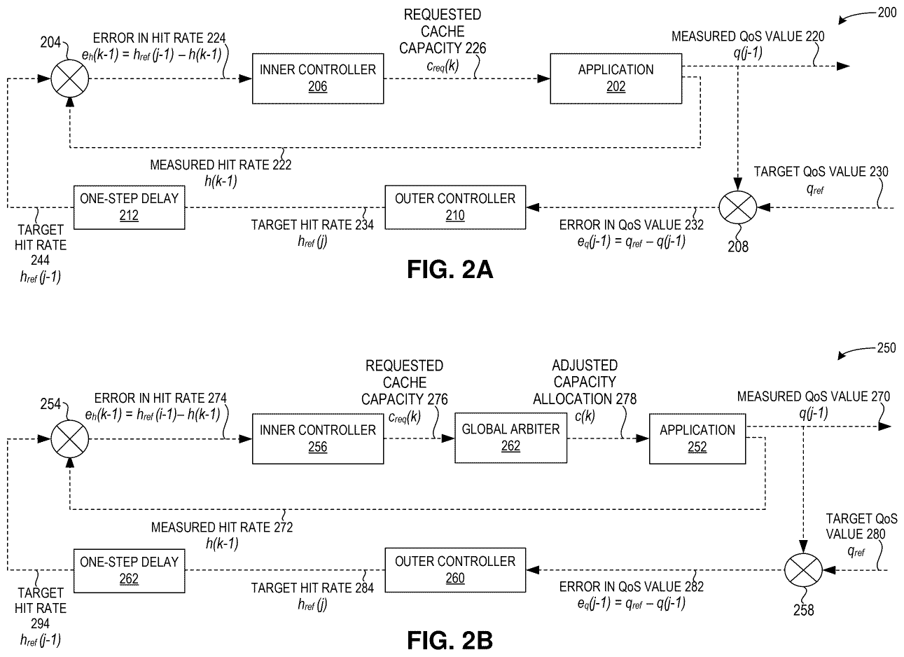

FIG. 1A illustrates an environment 100 which facilitates cache management for multiple applications, including multiple local capacity controllers (LCCs) 102, 104, and 106 and a global arbiter controller (GAC) 108, in accordance with an aspect of the present application. In environment 100, each LCC may determine its desired cache capacity for a respective application (as described below in relation to FIGS. 2A and 2B) and send that desired cache capacity as the requested cache capacity to the GAC, which can apply a set of rules in order to optimally allocate the actual cache capacity to each LCC for its respective application. For example: LCC 102 may send a requested cache capacity (c_{req1}) 112 to GAC 108; LCC 104 may send a requested cache capacity (c_{req2}) 114 to GAC 108; and LCC 106 may send a requested cache capacity (c_{req3}) 116 to GAC 108. GAC 108 may receive these multiple cache capacity requests 112-116 and more cache capacity requests from other LCCs (not shown).

GAC 108 may adjust the requested cache capacity for a respective application by applying a set of rules, based on information or hints provided by or related to the respective application. For example, GAC 108 may apply a first rule and allocate the cache partitions for the applications (i.e., to their corresponding LCCs) based on a lesser of the desired cache capacity and a minimum cache capacity acceptable to a respective application. Next, GAC 108 may apply a second rule and allocate the cache partitions for the applications based on the desired cache capacity ordered by a priority assigned to the respective application and a remaining cache capacity to be allocated. That is, if any cache capacity remains after applying the first rule, GAC 108 may allocate additional cache capacity to applications based on their respective priorities. Next, GAC 108 may apply a third rule and allocate the cache partitions for the applications based on a weight assigned to the respective application. That is, if any cache capacity remains after applying the first and second rules, GAC 108 may allocate additional cache capacity to applications based on their weights.

Thus, as depicted in environment 100, GAC 108 may determine, upon applying the rules, to adjust the requested cache capacity 112, 114, and 116 from, respectively, LCCs 102, 104, and 106. GAC 108 may adjust the desired cache capacity by determining the optimal allocated cache capacity for each LCC. For example: GAC 108 may determine that an allocated cache capacity (c₁) 122 is to be assigned as the cache partition for the respective application associated with LCC 102; GAC 108 may determine that an allocated cache capacity (c₂) 124 is to be assigned as the cache partition for the respective application associated with LCC 104; and GAC 108 may determine that an allocated cache capacity (c₃) 126 is to be assigned as the cache partition for LCC 106. The role of GAC 108 in the adaptive cache capacity controller is described further below in relation to FIG. 2B.

FIG. 1B illustrates a diagram 130 of a global cache space 132 with allocated cache partitions 142, 144, and 146, based on the environment of FIG. 1A, in accordance with an aspect of the present application. Diagram 130 depicts how the system has determined the optimal cache partition size for each application and also how the system has determined how to balance the partition sizes between the applications. Allocated cache partition (c1) 142 may correspond to allocated cache capacity 122 in FIG. 1A; allocated cache partition (c2) 144 may correspond to allocated cache capacity 124 in FIG. 1A; and allocated cache partition (c3) 146 may correspond to allocated cache capacity 126 in FIG. 1A. Global cache space 132 may include memory that is distributed across a plurality of compute nodes (e.g., in dynamic random access memory (DRAM) of the compute nodes) and may also be distributed across the memory of dedicated memory storage or memory servers.

FIG. 2A depicts an adaptive cache capacity controller 200, in accordance with an aspect of the present application. Controller 200 may reside as a hardware or software component in a network device. Controller 200 may include two individual controllers 206 and 210 which perform different functions. The functions performed by the two individual controllers 206 and 210 may also be performed by fewer or more components, modules, or entities associated with the network device. Controller 206 may be referred to as an “inner controller” 206 since it performs tasks corresponding to an inner loop based on a first “epoch” (i.e., a first time interval), and controller 210 may be referred to as an “outer controller 210” since it performs tasks corresponding to an outer loop based on a second “epoch” (i.e., a second time interval) which is longer than the first epoch.

Inner controller 206 can adjust the requested cache capacity in order to regulate the cache hit rate towards a target cache hit rate, while outer controller 210 can adjust the target hit rate based on a difference between a measured QoS value or metric and a target QoS value or metric (e.g., response time).

The cache hit rate for any arbitrary workload is a monotonically non-decreasing function of the cache capacity. That is, if the cache capacity is increased for any workload, the hit rate can only stay the same or improve for that workload, which can be expressed as follows:

$$h ( {c}_{0} + {Δ}_{c} ) \approx h ( {c}_{0} ) + \frac{\partial h}{\partial c} {\vert}_{{c}_{0}} {Δ}_{c} , \qquad Equation ( 1 )$$

where h is the hit rate, c is the cache capacity, c₀ is the current assigned capacity, and Δ_{c} is a small change in the capacity. Thus, the system can use an adaptive control technique to adaptively adjust the cache capacity in order to achieve any target hit rate independent of the workload.

The described aspects can operate based on epochs or time intervals, and each application may use some known fraction of the total cache (i.e., global cache space 132 as described above in relation to FIG. 1B). The cache hit rate may be monitored as a common metric in order to determine whether to provision more or less cache capacity to a respective application. Controlling the cache hit rate may be more intuitive because the cache hit rate can be more directly related to the cache capacity. For each application, the system can measure the corresponding hit rate observed by a respective application for a given time epoch k−1. At the end of that epoch, the system may analyze the observed hit rate or other metrics, and the system may subsequently adjust the allocated capacity for the next time epoch k. Assume the following variables:
c(k) is the cache capacity assigned to a respective application for epoch k,
u(k) is the capacity usage observed during epoch k,
h(k) is the cache hit rate measured during epoch k, and
q(j) is the QoS value (e.g., mean response time) measured during epoch j.

The cache hit rate h(k) and the cache capacity c(k) may have a non-linear bimodal relationship. For example, the system can approximate the cache hit rate h(k) using the following model:

$$h ( k ) = \{ \begin{matrix}\frac{c ( k )}{W ( k )} , & c ( k ) < W ( k ) \\ 1 , & c ( k ) \geq W ( k )\end{matrix} \} \qquad Equation ( 2 )$$

where W(k) is the working set size which represents the maximum amount of accessed data for a given workload during epoch k. When the working set size W(k) is greater than the cache capacity c(k), the cache is under-provisioned and the cache hit rate h(k) is proportional to the cache capacity c(k) (as in the top line of Equation (2)). However, when the cache capacity c(k) is greater than the working set size W(k), the cache is over-provisioned and is thus large enough to hold the entire active working set, resulting in a cache hit rate h(k) of 1 (i.e., 100%) (as in the bottom line of Equation (2)). Thus, the described aspects provide a feedback control system which can adaptively adjust the cache capacity for a single application based on the non-linear bimodal relationship between the cache capacity and the cache hit ratio.

In FIG. 2A, application 202 may run and output two values. The first value can be a measured QoS value q(j−1) (220), and this first value may be used by outer controller 210 as described below. The second value can be a measured hit rate h(k−1) (222), and this second value may be used by inner controller 206 to determine the desired cache capacity for a current first time interval creg (k) as follows:

$${c}_{r e q} ( k ) = c ( k - 1 ) + {G}_{1} ( k ) \cdot {e}_{h} ( k - 1 ) \qquad Equation ( 3 )$$

$${G}_{1} ( k ) = \{ \begin{matrix}{λ}_{1} \frac{c ( k - 1 )}{{h}_{ref}} , & c ( k - 1 ) = u ( k - 1 ) & \\ & & = λ \frac{u ( k - 1 )}{{h}_{r e f}} \\ {λ}_{2} \frac{u ( k - 1 )}{{h}_{ref}} , & c ( k - 1 ) > u ( k - 1 ) & \end{matrix} \} \qquad Equation ( 4 )$$

$${e}_{h} ( k - 1 ) = {h}_{r e f} ( j - 1 ) - h ( k - 1 ) \qquad Equation ( 5 )$$

In Equation (3), eₕ(k−1) indicates the error in the hit rate, or the “first” difference between the target hit rate over a prior second time interval h_{ref}(j−1) and the measured hit rate over a prior first time interval h(k−1), as shown in Equation (5). The target hit rate h_{ref} may be set at a default value when application 202 initially runs. Application 202 may run for several first time intervals k in order for the application to settle down and output accurate measured QoS values (220) and measured hit rates (222).

The first difference eₕ(k−1) can be computed (function 204), resulting in an error in hit rate (224). Inner controller 206 can scale this first difference by a first gain parameter G₁. G₁ is a gain parameter that can self-tune adaptively based on the measured cache capacity used in the last interval u(k−1). In accordance with an aspect of the present application, the adaptive gain parameter G₁ can be based on the non-linear bimodal relationship between the cache hit ratio and the cache capacity. When the cache capacity is under-provisioned (i.e., cache usage u(k−1) is equal to assigned cache capacity c(k−1), as in the top line of Equation (4)), the cache hit rate is capped by the capacity. As a result, inner controller 206 may need to aggressively allocate more capacity to quickly converge to the target hit rate. However, when the cache capacity is over-provisioned (i.e., cache usage u(k−1) is less than the assigned cache capacity c(k−1), as in the bottom line of Equation (4)), it may be desirable for the controller to slowly decrease the capacity without overshooting the target, as overshooting the target may lead to a large QoS violation (e.g., longer response times).

The variables 11 and 12 can be used, respectively, in the bottom and top lines of Equation (4) to account for the adaptive gain which is a dynamic value based on the non-linear bimodal relationship between the measured hit rate h(k−1) and the identified cache capacity for the prior first time interval c(k−1).

Thus, inner controller 206 can adjust its desired cache capacity c_{req}(k) (226) based on the measured hit rate for a prior first time interval h(k−1) (222) and the target hit rate over a prior second time interval h_{ref}(j−1) (244), i.e., by performing a function 204 to determine the error in the hit rate for the prior first time interval eₕ(k−1) (224) and computing a summation of the cache capacity assigned for the prior first time interval c(k−1) and the first difference eₕ(k−1) (224) scaled by the first gain parameter G₁ (k). This desired (or requested) cache capacity may be assigned to application 202 as its allocated cache partition of a global cache space. In addition, the requested cache capacity c_{req}(k) may be submitted to a global arbiter controller (such as GAC 108 in FIG. 1A), which can apply a set of rules and adjust the requested cache capacity for application 202, as described below in relation to FIG. 2B.

In the described aspects, outer controller 210 can enable an automatic adjustment of the target hit rate h_{ref} based on the target QoS value. Application 202 may run for a second time interval j in order to output the measured QoS value q(j−1) (220). In general, the second time interval j is greater than the first time interval k, e.g., by a predetermined amount or ratio. That is, application 202 may run and output the measured hit rate h(k−1) (222) over a shorter epoch k (e.g., 10 seconds) and also output the measured QoS value q(j−1) (220) over a longer epoch j (e.g., 1 minute). This allows outer controller 210 to regulate the cache hit rate for a current second time interval h_{ref}(j) as follows:

h_{ref}(j)=h_{ref}(j−1)−G₂·e_{q}(j−1) Equation (6)

e_{q}(j−1)=q_{ref}−q(j−1) Equation (7)

In Equation (6), e_{q}(j−1) indicates the error in the QoS value, or the “second” difference between the target QoS value q_{ref} and the measured QoS value over the prior second time interval q(j−1), as shown in Equation (7).

The second difference e_{q}(j−1) can be computed (function 208), resulting in error in QoS value (232). Outer controller 210 can scale this second difference by a second gain parameter G₂. In the described aspects, which use response time or latency as the QoS metric, G₂ is a fixed gain parameter based on a monotonically non-decreasing relationship between the target hit rate and the measured QoS value. When using response time or latency as the QoS metric, the response time can be inversely proportional to the target hit rate, which results in the target hit rate h_{ref}(j) being a difference (rather than a summation, as in Equation (3)) between the target hit rate for the prior second time interval h_{ref}(j−1) and the second difference e_{q} (j−1) scaled by the second gain parameter G₂, as in Equation (6).

In some aspects, when using a different QoS metric which is proportional to the target hit rate, the target hit rate h_{ref}(j) may be a summation of the target hit rate for the prior second time interval h_{ref}(j−1) and the second difference e_{q} (j−1) scaled by the second gain parameter G₂ (similar to the summation in Equation (3)). Furthermore, while the second gain parameter G₂ is depicted as a fixed non-dynamic value in Equation (6) based on the monotonically non-decreasing relationship between the target hit rate and the measured QoS value, other QoS metrics may be used which have a relationship with the target hit rate that calls for using an adaptive gain parameter G₂.

Thus, outer controller 210 can update the target hit rate for the current second time interval h_{ref}(j) (234) based on the measured QoS value for a prior second time interval q(j−1) (220) and the target QoS value q_{ref} (230), i.e., by performing a function 208 to determine the error in QoS value for the prior second time interval e_{q}(j−1) (232) and computing a difference between the target hit rate for the prior second time interval h_{ref}(j−1) and the second difference e_{q}(j−1) (232) scaled by the second gain parameter G₂. After a one-step delay (212), the calculated hit rate for the current second time interval h_{ref}(j) (234) can be used as the target hit rate for the prior second time interval h_{ref}(j−1) (244). This target hit rate h_{ref}(j−1) (244) may be output and fed into the computation performed (at function 204) by inner controller 206 to obtain the error in hit rate (224, as described above in relation to Equation (5)), thereby adjusting the requested cache capacity by regulating the cache hit rate towards the updated target hit rate.

FIG. 2B depicts an adaptive cache capacity controller 250, including a global arbiter controller 262, in accordance with an aspect of the present application. Similar to controller 200 in FIG. 2A, controller 250 may reside as a hardware or software component in a network device. Controller 250 may include two individual controllers (inner controller 256 and outer controller 260) which perform different functions (similar to, respectively inner controller 206 and outer controller 210 of FIG. 2A). Controller 250 may also include global arbiter controller 262. The functions performed by the two individual controllers 256 and 260 and by GAC 262 may also be performed by fewer or more components, modules, or entities associated with the network device.

Similar to application 202 in FIG. 2A, application 252 may run and output two values. The first value can be a measured QoS value q(j−1) (270) and the second value can be a measured hit rate h(k−1) (272). These values can be used as described below. Similar to the functions performed by inner controller 206 and outer controller 210 in FIG. 2A, inner controller 256 can adjust its desired cache capacity c_{req}(k) (276) based on the measured hit rate for a prior first time interval h(k−1) (272) and the target hit rate over a prior second time interval h_{ref}(j−1) (294), i.e., by performing a function 254 to determine the error in the hit rate for the prior first time interval eₕ(k−1) (274) and computing a summation of the cache capacity assigned for the prior first time interval c(k−1) and the first difference eₕ(k−1) (274) scaled by the first gain parameter G₁ (k), as described above in relation to Equations (3)-(5). Furthermore, outer controller 260 can update the target hit rate for the current second time interval j h_{ref}(j) (284) based on the measured QoS value for a prior second time interval q(j−1) (270) and the target QoS value q_{ref} (280), i.e., by performing a function 258 to determine the error in QoS value for the prior second time interval e_{q}(j−1) (282) and computing a difference between the target hit rate for the prior second time interval h_{ref}(j−1) and the second difference e_{q}(j−1) (282) scaled by the second gain parameter G₂, as described above in relation to Equations (6)-(7). After a one-step delay (262), the calculated hit rate for the current second time interval h_{ref}(j) (284) can be used as the target hit rate for the prior second time interval h_{ref}(j−1) (294). This target hit rate h_{ref}(j−1) (294) may be output and fed into the computation performed (at function 254) by inner controller 256, thereby adjusting the requested cache capacity by regulating the cache hit rate towards the updated target hit rate.

In FIG. 2B, controller 250 also depicts GAC 262, which can take as input the requested cache capacity from multiple LCCs (e.g., a requested cache capacity c_{req}(k) (276) from inner controller 256, or any of requested cache capacity 112, 114, and 116 of FIG. 1A) and adjust the requested cache capacity from each LCC by applying a set of rules based on information associated with a respective application. GAC 262 may obtain this information from various entities, including, e.g., from the application itself, a central entity, another network device, or system configurations. The information may include, e.g.: a minimum cache capacity acceptable to a respective application; a priority assigned to the respective application; and a weight assigned to a respective application.

As described above in relation to FIG. 1A, GAC 262 can allocate the cache partition for each application and corresponding LCC by sequentially applying the following rules based on, e.g.: a lesser of the desired cache capacity and the minimum cache capacity; a priority assigned to the respective application and a remaining global cache space to be allocated; and a weight assigned to the respective application. For example, in FIG. 2B, GAC 262 may apply the ordered set of rules and adjust requested cache capacity c_{req}(k) (276) to an adjusted capacity allocation c(k) (278). The system can subsequently allocate the adjusted capacity c(k) (278) to application 252 as its cache partition for that epoch or time interval k.

Thus, the inner controller of the LCC can adjust the requested cache capacity for an application based on the previously assigned capacity and the difference between target and measured hit rates (as in Equations (3)-(5)). Concurrently, the outer controller of the LCC can modify the target hit rate based on its previous value and the discrepancy between target and measured QoS values (as in Equations (6)-(7)). This adjusted target hit rate can be used to compute further cache capacity requests. The LCC (i.e., by the inner controller and the outer controller) may perform these two functions in a nested loop, where the first function may be performed over a first time interval and the second function may be performed over a second time interval which is greater than the first time interval. Subsequently, LCCs associated with multiple applications may send their requested cache capacity to the GAC, which can adjust the allocation of the cache partition to each LCC based on the above-described set of rules. The operations and interactions of the LCCs with the GAC may result in a system which can determine the optimal cache capacity per application and also balance the cache partition among the applications, thus resulting in efficient performance isolation between the applications.

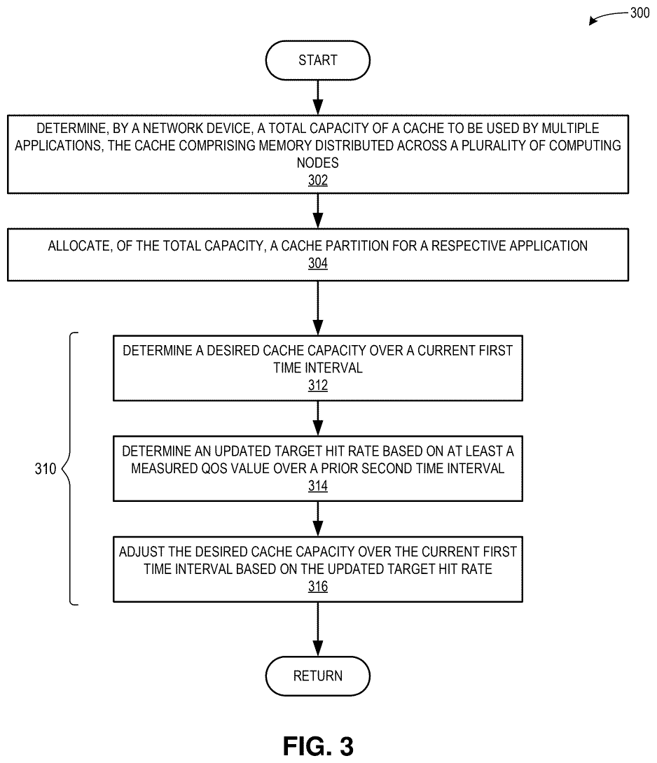

FIG. 3 presents a flowchart 300 illustrating a method which facilitates cache management for multiple applications, in accordance with an aspect of the present application. During operation, the system determines, by a network device, a total capacity of a cache to be used by multiple applications, the cache comprising memory distributed across a plurality of compute nodes (operation 302). The cache may be referred to as a “global cache” which is spread across a network including compute nodes and dedicated memory servers, rather than being confined to a single machine. For example, global cache space 132 in FIG. 1B may include a combination of DRAM of compute nodes and dedicated storage servers, which may allow cached data to be accessible to and shared by all instances of an application or system.

The system allocates, of the total capacity, a cache partition for a respective application (operation 304). The system can include a local capacity controller which performs two functions. For example, adaptive cache controller 200 in FIG. 2A may include inner controller 206 which adjusts the requested cache capacity based on the previously assigned cache capacity, the target hit rate, and the measured hit rate, as described above in relation to function 204. Outer controller 210 can modify the target hit rate based on its previous value, a target QoS value, and a measured QoS value, as described above in relation to function 208. Each controller may perform the functions described above in relation to FIGS. 2A and 2B.

Allocating the cache partition for the respective application can include an operation 310, which comprises operations 312, 314, and 316. The system determines a desired cache capacity over a current first time interval (operation 312). For example, inner controller 206 in FIG. 2A may determine requested cache capacity c_{req}(k) (226) based on at least the measured hit rate, the target hit rate, and the error in the hit rate (i.e., the first difference between the target hit rate and the measured hit rate). Inner controller 206 may also determine requested cache capacity 226 based on the first gain parameter G₁ and the computations described above in relation to FIG. 2A and Equations (3)-(5).

The system determines an updated target hit rate based on at least a measured quality-of-service (QoS) value over a prior second time interval (operation 314). In FIG. 2A, outer controller 210 can determine the target hit rate h_{ref}(j) (234) based on at least the measured QoS value, the target QoS value, and the error in the QoS value (i.e., the second difference between the target QoS value and the measured QoS value). Outer controller 210 may also determine target hit rate 234 based on the second gain parameter G₂ and the computations described above in relation to FIG. 2A and Equations (6)-(7).

The system adjusts the desired cache capacity over the current first time interval based on the updated target hit rate (operation 316). For example, inner controller 206 can receive as input the updated target hit rate 234 from outer controller 210 (which is computed based on outer controller 210 performing function 208). Inner controller 206 can perform function 204, which involves computing the error in hit rate 234 (i.e., the first difference) and subsequently using that difference to determine the requested cache capacity, as described above in relation to FIG. 2A and Equations (3)-(5). The system may continue performing both the functions of inner controller 206 over the first time intervals (k) and the functions of outer controller 210 over the second time intervals (j), as described above in relation to FIGS. 1A and 2A. The operation described in flowchart 300 returns.

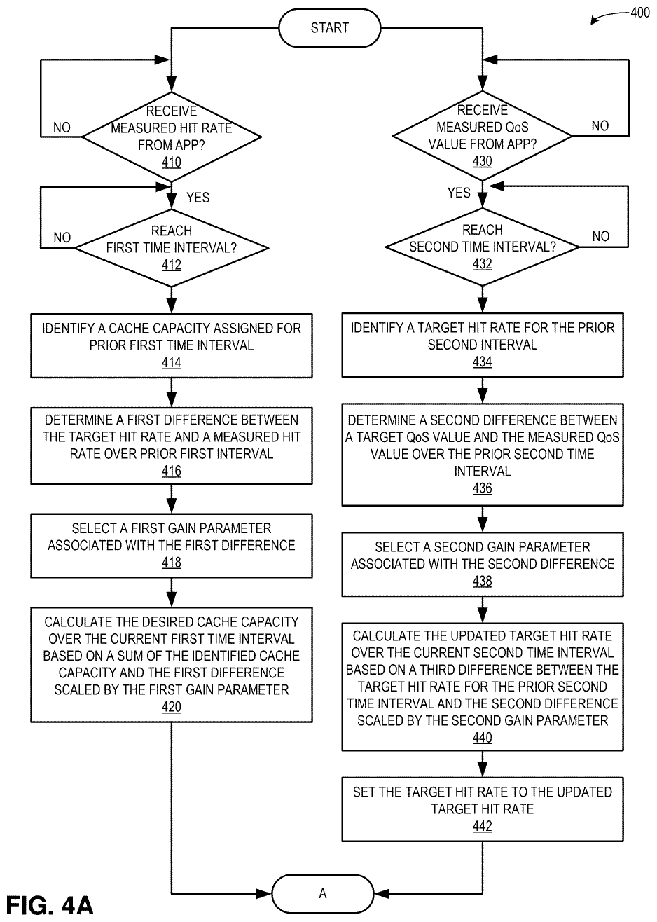

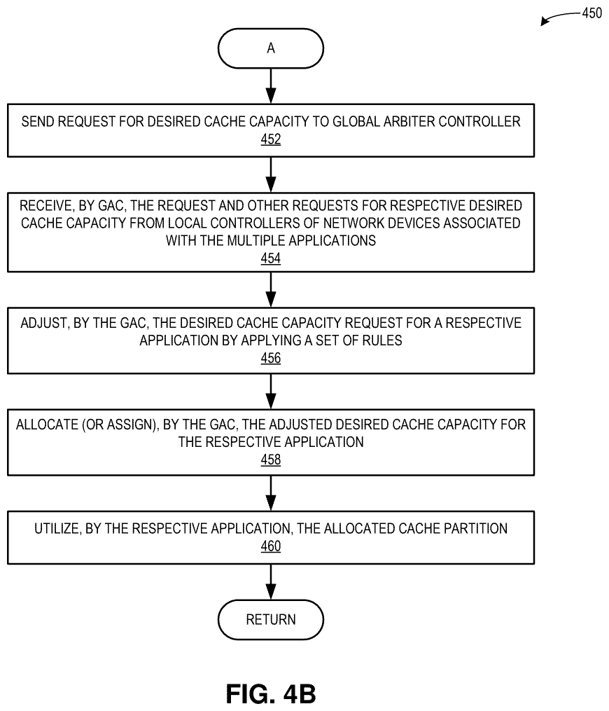

FIG. 4A presents a flowchart 400 illustrating a method which facilitates cache management for multiple applications, in accordance with an aspect of the present application. Flowchart 400 depicts operations performed by an inner controller of an LCC as part of an inner loop (on the left side, including decisions 410-412 and operations 414-420) as well as operations performed by an outer controller of an LCC as part of an outer loop (on the right side, including decisions 430-432 and operations 434-440). The operations performed by the inner controller as depicted on the left side of flowchart 400 may be based on a first time interval k, and the operations performed by the outer controller as depicted on the right side of flowchart 400 may be based on a second time interval j, where the second time interval is greater than the first time interval. Accordingly, the operations performed by the inner controller and the outer controller may be performed concurrently, as described above in relation to the loops of FIGS. 2A and 2B.

If the system does not receive a measured hit rate from an application (decision 410), the operation waits to receive the measured hit rate. If the system does receive the measured hit rate from the application (decision 410), and if the first time interval k has not been reached (decision 412), the operation waits until the first time interval is reached. If the system does receive the measured hit rate from the application (decision 410) and if the first time interval k has been reached (decision 412), the system identifies a cache capacity assigned for a prior first time interval (operation 414). For example, inner controller 206 in FIG. 2A may identify c(k−1) as described above in relation to Equation (3).

The system determines a first difference between the target hit rate and a measured hit rate in the cache over the prior first time interval (operation 416). The first difference may be the error in the hit rate, as described above in relation to Equation (5) and element 224 of FIG. 2A.

The system selects a first gain parameter associated with the first difference (operation 418). The first gain parameter may be the adaptive self-tuning parameter G₁ described above in relation to FIG. 2A and Equation (4), which is further based on two λ values (λ₁ and λ₂) chosen based on the relationship between the assigned and utilized capacity for the prior first time interval.

The system calculates the desired cache capacity over the current first time interval based on a sum of: the identified cache capacity; and the first difference scaled by the first gain parameter (operation 420). As described above in relation to FIG. 2A, inner controller 206 may calculate the requested cache capacity for the current first time interval k (226) based on a sum of: the identified cache capacity (assigned during the prior first time interval); and the error in the hit rate scaled by the first gain parameter, as described above in relation to Equation (3). The operation continues at Label A of FIG. 4B.

If the system does not receive a measured QoS value from the application (decision 430), the operation waits to receive the measured QoS value. If the system does receive the measured QoS value from the application (decision 410), and if the second time interval j has not been reached (decision 432), the operation waits until the second time interval is reached. If the system does receive the measured QoS value from the application (decision 430) and if the second time interval j has been reached (decision 432), the system identifies a target hit rate for the prior second time interval (operation 434). For example, outer controller 210 in FIG. 2A may identify h_{ref}(j−1) as described above in relation to Equation (6).

The system determines a second difference between a target QoS value and the measured QoS value over the prior second time interval (operation 436). The second difference may be the error in the QoS value, as described above in relation to FIG. 2A and Equation (7).

The system selects a second gain parameter associated with the second difference (operation 438). The second gain parameter may be the fixed parameter G₂ described above in relation to FIG. 2A and Equation (6). In some aspects, the second gain parameter G₂ may be a dynamically changing value, similar to the adaptive first gain parameter G₁, depending on whether the relationship is non-linear, bimodal, monotonic, etc.

The system calculates the updated target hit rate over the current second time interval based on a third difference between: the target hit rate for the prior second time interval; and the second difference scaled by the second gain parameter (operation 440). As described above in relation to FIG. 2A, outer controller 210 may calculate the updated target hit ratio for the current second time interval h_{ref}(j) (234) based on a difference between: the target hit rate for the prior second time interval; and the error in the QoS value scaled by the second gain parameter as described above in relation to FIG. 2A and Equations (6)-(7). The operation continues at Label A of FIG. 4B.

FIG. 4B presents a flowchart 450 illustrating a method which facilitates cache management for multiple applications, in accordance with an aspect of the present application. The system (e.g., by a local cache controller (LCC)) sends a request for desired cache capacity to a global arbiter controller (GAC) (operation 452). For example, in FIG. 1A, LCC 104 sends requested cache capacity c_{req2} (114) to GAC 108. As another example, in FIG. 2B, inner controller 256 sends requested cache capacity c_{req}(k) (276) to GAC 262.

The system receives, by the GAC, the request and other requests for respective desired cache capacity from LCCs of network devices associated with the multiple applications (operation 454). For example, GAC 108 in FIG. 1A can receive requested cache capacity 112, 114, and 116 from, respectively, LCCs 102, 104, and 106.

The system adjusts, by the GAC, the desired cache capacity request for a respective application by applying a set of rules (operation 456). GAC 108 in FIG. 1A and GAC 262 of FIG. 2B can apply the set of rules to allocate the global cache space between the multiple applications. The rules may be a set of ordered or sequential rules and may be based on information provided by or associated with a respective application. As described above in relation to GAC 262, the information may include, e.g.: a minimum cache capacity acceptable to a respective application; a priority assigned to the respective application; and a weight assigned to a respective application.

The system allocates (or assigns), by the GAC, the adjusted desired cache capacity for the respective application (operation 458). In FIG. 1A, GAC 108 may allocate adjusted cache capacity c₁ (122) to LCC 102 in response to receiving the requested c_{req1} (112) from LCC 102. Additionally, in FIG. 2B, GAC 262 may allocate adjusted capacity c(k) (278) of a global distributed cache space (e.g., global cache space 132 in FIG. 1B) to application 252.

The system utilizes, by the respective application, the allocated cache partition (operation 460). For example, application 252 in FIG. 2B may be allocated adjusted capacity c(k) (278), which can allow application 252 to utilize this allocated cache partition in order to continue running. The operation returns.

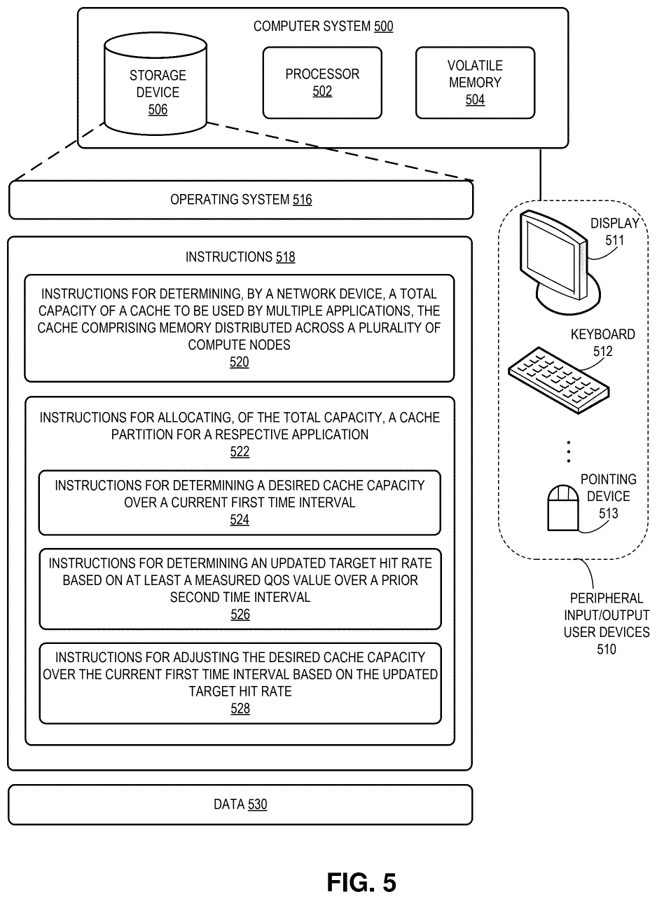

FIG. 5 illustrates a computer system 500 which facilitates cache management for multiple applications, in accordance with an aspect of the present application. Computer system 500 includes a processor 502, a memory 504, and a storage device 506. Memory 504 may include a volatile memory (e.g., random access memory (RAM)) that serves as a managed memory and can be used to store one or more memory pools. Furthermore, computer system 500 may be coupled to peripheral I/O user devices 510 (e.g., a display device 511, a keyboard 512, and a pointing device 513). Storage device 506 includes non-transitory computer-readable storage medium and stores an operating system 516, instructions 518, and data 530. Computer system 500 may include fewer or more entities or instructions than those shown in FIG. 5.

Instructions 518, when executed by computer system 500, can cause computer system 500 to perform methods and/or processes described in this disclosure. Specifically, instructions 518 may include instructions 520 for determining, by a network device, a total capacity of a cache to be used by multiple applications, the cache comprising memory distributed across a plurality of compute nodes, as described above in relation to global cache space 132 of FIG. 1B and operation 302 of FIG. 3.

Instructions 518 may include instructions 522 for allocating, of the total capacity, a cache partition for a respective application, as described above in relation to the functions performed by inner controller 206 and outer controller 210 of FIG. 2A and operations 304 and 310 of FIG. 3.

Instructions 522 for allocating the cache partition for the respective application may comprise instructions 524 for determining a desired cache capacity over a current first time interval, as described above in relation to the inner loop function performed by inner controller 206 in FIG. 2A and by inner controller 256 in FIG. 2B, in, respectively, functions 204 and 254. Determining the desired cache capacity is also described above in relation to Equations (3)-(5) and operation 312 of FIG. 3.

Instructions 522 for allocating the cache partition for the respective application may further comprise instructions 526 for determining an updated target hit rate based on at least a measured quality-of-service (QoS) value over a prior second time interval, as described above in relation to the outer loop function performed by outer controller 210 in FIG. 1A and outer controller 260 in FIG. 2B, in, respectively, functions 208 and 258. Determining the updated target hit rate is also described above in relation to Equations (6)-(7) and operation 314 of FIG. 3.

Instructions 522 for allocating the cache partition for the respective application may further comprise instructions 528 for adjusting the desired cache capacity over the current first time interval based on the updated target hit rate, as described above in relation to the interaction between the two loops and functions performed by inner/outer controllers 206/210 of FIG. 2A and inner/outer controllers 256/260 of FIG. 2B, as well as operation 316 of FIG. 3.

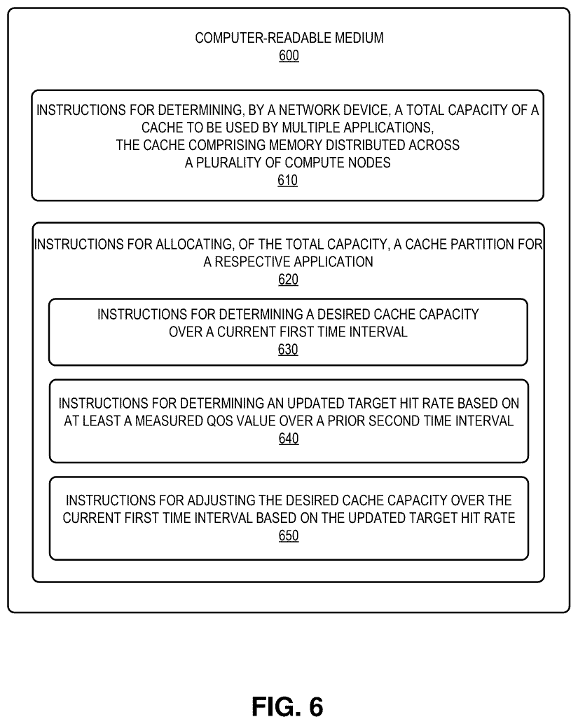

Instructions 518 may include more instructions than those shown in FIG. 5. For example, instructions 518 may include instructions for executing the operations described above in relation to: the environment of FIGS. 1A and 1B; the functions and communications of FIGS. 2A and 2B; the operations of the flowcharts in FIGS. 3, 4A, and 4B; and the instructions of CRM 600 in FIG. 6.

Data 530 can include any data that is required as input or that is generated as output by the methods, operations, communications, and/or processes described in this disclosure. Specifically, data 530 can store at least: a total capacity of a cache; an indicator or identifier of a network device or an application; an identifier of DRAM, a compute node, or a dedicated memory server; an indicator of an application and a corresponding LCC; an indicator of allocated cache partition or cache capacity; a desired cache capacity; an assigned cache capacity; an amount of cache capacity utilized or used; a current or prior first time interval; a current or prior second time interval; a hit rate; a target hit rate; a measured hit rate; a QoS value or metric; a target QoS value or metric; a measured QoS value or metric; an updated target hit rate; an adjusted desired cache capacity; a predetermined amount; a cache capacity assigned for a prior first time interval; a first difference; a first gain parameter; a sum; an identified target hit rate for a prior second time interval a second difference; a second gain parameter; an adaptive or dynamic gain parameter; a fixed gain parameter; a third difference; a sum; an indicator of a non-linear and bimodal relationship; an indicator of a monotonic relationship; a fixed value; a dynamic value; an indicator of a non-linear relationship; a set of rules; a set of ordered rules; a set of sequential rules; a minimum acceptable cache capacity; a priority; and a weight.

FIG. 6 illustrates a computer-readable medium (cRM) 600 which facilitates cache management for multiple applications, in accordance with an aspect of the present application. CRM 600 can be a non-transitory computer-readable medium or device storing instructions that when executed by a computer or processor cause the computer or processor to perform a method. CRM 600 may store instructions 610 for determining (i.e., to determine), by a network device, a total capacity of a cache to be used by multiple applications, the cache comprising memory distributed across a plurality of compute nodes, as described above in relation to global cache space 132 of FIG. 1B and operation 302 of FIG. 3.

CRM 600 may store instructions 620 for allocating, of the total capacity, a cache partition for a respective application, as described above in relation to the functions performed by inner controller 206 and outer controller 210 of FIG. 2A and operations 304 and 310 of FIG. 3.

In CRM 600, instructions 620 for allocating the cache partition for the respective application may include instructions 630 for determining a desired cache capacity over a current first time interval, as described above in relation to the inner loop function performed by inner controller 206 in FIG. 2A and by inner controller 256 in FIG. 2B, in, respectively, functions 204 and 254. Determining the desired cache capacity is also described above in relation to Equations (3)-(5) and operation 312 of FIG. 3.

In CRM 600, instructions 620 for allocating the cache partition for the respective application may include instructions 640 for determining an updated target hit rate based on at least a measured quality-of-service (QoS) value over a prior second time interval, as described above in relation to the outer loop function performed by outer controller 210 in FIG. 1A and outer controller 260 in FIG. 2B, in, respectively, functions 208 and 258. Determining the updated target hit rate is also described above in relation to Equations (6)-(7) and operation 314 of FIG. 3.

In CRM 600, instructions 620 for allocating the cache partition for the respective application may include instructions 650 for adjusting the desired cache capacity over the current first time interval based on the updated target hit rate, as described above in relation to the interaction between the two loops and functions performed by inner/outer controllers 206/210 of FIG. 2A and inner/outer controllers 256/260 of FIG. 2B, as well as operation 316 of FIG. 3.

CRM 600 may include more instructions than those shown in FIG. 6. For example, CRM 600 may also store instructions for executing the operations described above in relation to: the environment of FIGS. 1A and 1B; the functions and communications of FIGS. 2A and 2B; the operations of the flowcharts in FIGS. 3, 4A, and 4B; and the instructions of computer system 500 in FIG. 5.

The term “network device” refers to any device, component, or computing entity which can provide a communication pipeline for packets sent from a “processing node” or an “endpoint node.” A processing or endpoint node can refer to a device, component, or hardware component which can operate as a source or a destination of data, including e.g., a control packet or a data packet. A network device may include an ingress network device, an intermediate or mid-fabric network device, or an egress or endpoint network device. An example of a network device may be a switch. A processing node or endpoint node can include an ingress node (which is an endpoint for data returned from a request) or an egress node (which is an endpoint for data sent from a request).

In general, the disclosed aspects provide a computing system, a method, and a computer-readable medium which facilitate cache management for multiple applications. The system determines, by a network device, a total capacity of a cache to be used by multiple applications, the cache comprising memory distributed across a plurality of compute nodes. The system allocates, of the total capacity, a cache partition for a respective application, by: determining a desired cache capacity over a current first time interval; determining an updated target hit rate based on at least a measured quality-of-service (QoS) value over a prior second time interval; and adjusting the desired cache capacity over the current first time interval based on the updated target hit rate.

In a variation on this aspect, the cache further comprises at least one of: dynamic random access memory (DRAM) of the plurality of compute nodes; or memory of dedicated memory servers.

In a further variation on this aspect, the system dynamically adjusts the desired cache capacity over subsequent first time intervals based on a previously assigned cache capacity and the updated target hit rate.

In a further variation, the second time interval is greater than the first time interval by a predetermined amount.

In a further variation, the system determines the desired cache capacity for the respective application over the current first time interval by performing the following operations. The system identifies a cache capacity assigned for a prior first time interval. The system determines a first difference between the updated target hit rate and a measured hit rate in the cache over the prior first time interval. The system selects a first gain parameter associated with the first difference. The system calculates the desired cache capacity over the current first time interval based on a sum of: the identified cache capacity; and the first difference scaled by the first gain parameter.

In a further variation, the system determines the updated target hit rate for the respective application over the current second time interval by performing the following operations. The system identifies a target hit rate for the prior second time interval. The system determines a second difference between a target QoS value and the measured QoS value over the prior second time interval. The system selects a second gain parameter associated with the second difference. The system calculates the updated target hit rate over the current second time interval based on a third difference between: the target hit rate for the prior second time interval; and the second difference scaled by the second gain parameter.

In a further variation, the first gain parameter comprises a dynamic value based on a non-linear and bimodal relationship between the measured hit rate and the identified cache capacity for the prior first time interval. The second gain parameter comprises at least one of: a fixed value based on a monotonic relationship between the updated target hit rate and the measured QoS value for the respective application; or a dynamic value based on a non-linear relationship between the updated target hit rate and the measured QoS value for the respective application.

In a further variation, the system allocates the cache partition for the respective application by adjusting the desired cache capacity for the respective application, e.g., by applying a set of rules. The set of rules comprises: allocating the cache partition based on a lesser of the desired cache capacity and a minimum cache capacity acceptable to the respective application; allocating the cache partition based on the desired cache capacity ordered by a priority assigned to the respective application and a remaining cache capacity to be allocated; and allocating the cache partition based on a weight assigned to the respective application.

In a further variation, the system receives, by a global cache controller associated with the network device, requests for desired cache capacity from local cache controllers of network devices associated with the multiple applications. The system adjusts, by the global cache controller, the desired cache capacity for the respective application by applying the set of rules.

In another aspect, a computing system comprises a processing resource and a storage device storing instructions which when executed by the processing resource cause the processing resource to perform a method. The method comprises determining, by a network device, a total capacity of a cache to be used by multiple applications, the cache comprising memory distributed across a plurality of compute nodes. The method further comprises allocating, of the total capacity, a cache partition for a respective application. Allocating the cache partition for the respective application comprises: determining a desired cache capacity over a current first time interval; determining an updated target hit rate based on at least a measured quality-of-service (QoS) value over a prior second time interval; and adjusting the desired cache capacity over the current first time interval based on the updated target hit rate. The computing system may also include additional instructions, including in relation to: the environment of FIGS. 1A and 1B; the functions and communications of FIGS. 2A and 2B; the operations of the flowcharts in FIGS. 3, 4A, and 4B; and the instructions of CRM 600 in FIG. 6.

In another aspect, a non-transitory computer-readable storage medium (or CRM) stores instructions which when executed by a processing resource or a computer cause the processing resource or computer to perform a method. The method comprises determining, by a network device, a total capacity of a cache to be used by multiple applications, the cache comprising memory distributed across a plurality of compute nodes. The method further comprises allocating, of the total capacity, a cache partition for a respective application. Allocating the cache partition for the respective application comprises: determining a desired cache capacity over a current first time interval; determining an updated target hit rate based on at least a measured quality-of-service (QoS) value over a prior second time interval; and adjusting the desired cache capacity over the current first time interval based on the updated target hit rate. The CRM may also store instructions for executing the operations described above in relation to: the environment of FIGS. 1A and 1B; the functions and communications of FIGS. 2A and 2B; the operations of the flowcharts in FIGS. 3, 4A, and 4B; and the instructions of computer system 500 in FIG. 5.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computing-implemented method, comprising:
determining, by a network device, a total capacity of a cache to be used by multiple applications, the cache comprising memory distributed across a plurality of compute nodes; and
allocating, of the total capacity, a cache partition for a respective application, wherein allocating the cache partition for the respective application comprises:
determining a desired cache capacity over a current first time interval;
determining an updated target hit rate based on at least a measured 8 quality-of-service (QoS) value over a prior second time interval; and
adjusting the desired cache capacity over the current first time interval based on the updated target hit rate.

2. The method of claim 1, the cache further comprising at least one of:
dynamic random access memory (DRAM) of the plurality of compute nodes; or
memory of dedicated memory servers.

3. The method of claim 1, further comprising:
dynamically adjusting the desired cache capacity over subsequent first time intervals based on a previously assigned cache capacity and the updated target hit rate.

4. The method of claim 1, wherein the second time interval is greater than the first time interval by a predetermined amount.

5. The method of claim 1, wherein determining the desired cache capacity for the respective application over the current first time interval comprises:
identifying a cache capacity assigned for a prior first time interval;
determining a first difference between the updated target hit rate and a measured hit rate in the cache over the prior first time interval;
selecting a first gain parameter associated with the first difference; and
calculating the desired cache capacity over the current first time interval based on a sum of:
the identified cache capacity; and
the first difference scaled by the first gain parameter.

6. The method of claim 5, wherein determining the updated target hit rate for the respective application over the current second time interval comprises:
identifying a target hit rate for the prior second time interval;
determining a second difference between a target QoS value and the measured QoS value over the prior second time interval;
selecting a second gain parameter associated with the second difference; and
calculating the updated target hit rate over the current second time interval based on a third difference between:
the target hit rate for the prior second time interval; and
the second difference scaled by the second gain parameter.

7. The method of claim 6,
wherein the first gain parameter comprises a dynamic value based on a non-linear and bimodal relationship between the measured hit rate and the identified cache capacity for the prior first time interval; and
wherein the second gain parameter comprises at least one of:
a fixed value based on a monotonic relationship between the updated target hit rate and the measured QoS value for the respective application; or
a dynamic value based on a non-linear relationship between the updated target hit rate and the measured QoS value for the respective application.

8. The method of claim 1, wherein allocating the cache partition for the respective application further comprises:
adjusting the desired cache capacity for the respective application by applying a set of rules, the set of rules comprising:
allocating the cache partition based on a lesser of the desired cache capacity and a minimum cache capacity acceptable to the respective application;
allocating the cache partition based on the desired cache capacity ordered by a priority assigned to the respective application and a remaining cache capacity to be allocated; and
allocating the cache partition based on a weight assigned to the respective application.

9. The method of claim 8, further comprising:
receiving, by a global cache controller associated with the network device, requests for desired cache capacity from local cache controllers of network devices associated with the multiple applications; and
adjusting, by the global cache controller, the desired cache capacity for the respective application by applying the set of rules.

10. A computing system comprising:
a processing resource; and
a storage device storing instructions which when executed by the processing resource cause the processing resource to perform a method, the method comprising:
determining, by a network device, a total capacity of a cache to be used by multiple applications, the cache comprising memory distributed across a plurality of compute nodes; and
allocating, of the total capacity, a cache partition for a respective application, wherein allocating the cache partition for the respective application comprises:
determining a desired cache capacity over a current first time interval;
determining an updated target hit rate based on at least a measured quality-of-service (QoS) value over a prior second time interval; and
adjusting the desired cache capacity over the current first time interval based on the updated target hit rate.

11. The computing system of claim 10, the method further comprising:
dynamically adjusting the desired cache capacity over subsequent first time intervals based on a previously assigned cache capacity and the updated target hit rate,
wherein the second time interval is greater than the first time interval by a predetermined amount.

12. The computing system of claim 10, wherein determining the desired cache capacity for the respective application over the current first time interval comprises:
identifying a cache capacity assigned for a prior first time interval;
determining a first difference between the updated target hit rate and a 5 measured hit rate in the cache over the prior first time interval;
selecting a first gain parameter associated with the first difference; and
calculating the desired cache capacity over the current first time interval based on a sum of:
the identified cache capacity; and
a result of the first difference scaled by the first gain parameter.

13. The computing system of claim 12, wherein determining the updated target hit rate for the respective application over the current second time interval comprises:
identifying a target hit rate for the prior second time interval;
determining a second difference between a target QoS value and the measured QoS value over the prior second time interval;
selecting a second gain parameter associated with the second difference; and
calculating the updated target hit rate over the current second time interval 8 based on a third difference between:
the target hit rate for the prior second time interval; and
a result of the second difference scaled by the second gain parameter.

14. The computing system of claim 13,
wherein the first gain parameter comprises a dynamic value based on a non-linear and bimodal relationship between the measured hit rate and the identified cache capacity for the prior first time interval; and
wherein the second gain parameter comprises at least one of:
a fixed value based on a monotonic relationship between the updated target hit rate and the measured QoS value for the respective application; or
a dynamic value based on a non-linear relationship between the updated target hit rate and the measured QoS value for the respective application.

15. The computing system of claim 10, the method further comprising:
adjusting the desired cache capacity for the respective application by applying a set of rules,
wherein the set of rules comprises:
allocating the cache partition based on a lesser of the desired cache capacity and a minimum cache capacity acceptable to the respective application;
allocating the cache partition based on the desired cache capacity ordered by a priority assigned to the respective application and a remaining cache capacity to be allocated; and
allocating the cache partition based on a weight assigned to the respective application.

16. The computing system of 15, the method further comprising:
receiving, by a global cache controller associated with the network device, requests for desired cache capacity from local cache controllers of network devices associated with the multiple applications; and
adjusting, by the global cache controller, the desired cache capacity for the respective application by applying the set of rules.

17. A non-transitory computer-readable medium storing instructions which when executed by a processing resource cause the processing resource to perform a method, the method comprising:
determining, by a network device, a total capacity of a cache to be used by multiple applications, the cache comprising memory distributed across a plurality of compute nodes; and
allocating, of the total capacity, a cache partition for a respective application, wherein allocating the cache partition for the respective application comprises:
determining a desired cache capacity over a current first time interval;
determining an updated target hit rate based on at least a measured quality-of-service (QoS) value over a prior second time interval; and
adjusting the desired cache capacity over the current first time interval based on the updated target hit rate.

18. The non-transitory computer-readable medium of claim 17, the method further comprising:
dynamically adjusting the desired cache capacity over subsequent first time intervals based on a previously assigned cache capacity and the updated target hit rate.

19. The non-transitory computer-readable medium of claim 17, wherein determining the desired cache capacity for the respective application over the current first time interval comprises:
identifying a cache capacity assigned for a prior first time interval;
determining a first difference between the updated target hit rate and a measured hit rate in the cache over the prior first time interval;
selecting a first gain parameter associated with the first difference; and
calculating the desired cache capacity over the current first time interval based on a sum of:
the identified cache capacity; and
a result of the first difference scaled by the first gain parameter.

20. The non-transitory computer-readable medium of claim 19, wherein determining the updated target hit rate for the respective application over the current second time interval comprises:
identifying a target hit rate for the prior second time interval;
determining a second difference between a target QoS value and the measured QoS value over the prior second time interval;
selecting a second gain parameter associated with the second difference; and
calculating the updated target hit rate over the current second time interval based on a third difference between:
the target hit rate for the prior second time interval; and
a result of the second difference scaled by the second gain parameter.
